(19) United States
(12) Patent Application Publication
(10) Pub. No.: US 2007/0270176 A1
(43) Pub. Date: Nov. 22, 2007

(54) Communications device

(76) Inventors: John C. Anderson, St. Joseph, MO (US); Tyler J. Ward, Gladstone, MO (US)

Correspondence Address: HARSHAW RESEARCH, INC., 210 W. TECUMSEH STREET, OTTAWA, KS, 66067, US

(21) Appl. No.: 11/436,013

(22) Filed: May 17, 2006

(51) Int. Cl. H04M 1/00

(52) U.S. Cl. 455/550.1

(57) ABSTRACT

A communications device for enabling a delivery person to communicate with a person at a remote location regarding the delivery of a package includes a housing for mounting near the entry to a residence or business. A processor is positioned in the housing in operative communication with electronic components for transmitting data to at least one remote device such as a cellular telephone, pager, or computer. The housing includes an actuator button for actuating the processor to establish two-way communication with the remote device and may include additional input devices such as a microphone, keypad, or camera. The camera enables the processor to transmit a picture to the remote device such that the authenticity of the delivery person may be verified prior to a remote user providing delivery instructions.

### BACKGROUND OF THE INVENTION

This invention relates to a communications device and, more particularly, to a device that enables a delivery person to communicate with a resident who is not present to receive a delivery.

Unfortunately, people are frequently not home to receive deliveries when the delivery service arrives with the package, such as from the United States Postal Service, UPS, or FedEx. These deliveries usually occur during normal business hours when residents may be at work. Unless prior arrangements have been made, the delivery person typically will not leave the package unattended at the residence. The package will either be delivered the next day or the package recipient must travel to the delivery company to pick it up.

In addition to delivery persons needing to contact a resident, emergency personnel such as firefighters may need to contact a homeowner in case of a fire so as to verify if any persons or pets may be inside the dwelling. If the firefighters were able to quickly verify this information, they may avoid engaging in a needless and dangerous rescue attempt. This would also apply to a neighbor or passerby who may be attempting a rescue in an otherwise dangerous situation. The difficulty is that the emergency personnel might not have immediate information on who the homeowner is or how to reach them.

Various devices have been proposed in the art for enabling a delivery person to communicate via a telephone signal resident to enable the receive instructions or authorization to leave the package unattended. Although assumably effective for their intended purposes, the existing devices or proposals do not provide multiple input devices for use by the delivery person or to verify the authenticity of the delivery person, e.g. a camera. Further, the existing devices do not enable emergency personnel to immediately contact the owner of the residence.

Therefore, it would be desirable to have a communications device that enables a delivery person to communicate in real time with a resident to receive instructions or authorization regarding a package. Further, it would be desirable to have a communications device that enables a resident to authenticate the identity of the delivery person. In addition, it would be desirable to have a communications device by which emergency personnel can communicate immediately with a resident of a dwelling so as to verify if any occupants or pets are inside.

### SUMMARY OF THE INVENTION

Accordingly, a communications device according to the present invention includes a housing for mounting to an entrance of a residence or business. A processor is situated in the housing and includes programming for transmitting data to at least one remote device, such as a cellular telephone, non-cellular telephone, pager, or computer. The housing includes an actuator for actuating the processor to communicate with the at least one remote device. A keyboard may be mounted on the housing for inputting alphanumeric data to the processor for transmission to a cellular telephone, say, through text messaging, or to a computer as e-mail. In addition, a camera may be mounted on the housing for taking a digital picture of the deliver person or even a video for transmission to a remote picture phone or computer. This enables a remote user to verify the identity of the delivery person.

The processor includes programming for receiving data from the at least one remote device and is in data communication with a speaker. Accordingly, instructions received from a remote user, for example to leave the package with a neighbor or in the garage, may be communicated back to the delivery person.

Therefore, a general object of this invention is to provide a communications device for two-way communication between a delivery person at the entrance to a residence and a remote resident.

Another object of this invention is to provide a communications device, as aforesaid, that includes at least one input device enabling the delivery person to enter data to a processor and communicate with at least one remote device.

Still another object of this invention is to provide a communications device, as aforesaid, having a camera for capturing and transmitting a picture of a delivery person to a remote communications device to enable a remote person to identify the delivery person.

Yet another object of this invention is to provide a communications device, as aforesaid, having a microphone or display for enabling a user at a remote communication device to communicate with the delivery person.

A further object of this invention is to provide a communications device, as aforesaid, that is weatherproof.

A still further object of this invention is to provide a communications device, as aforesaid, that can communicate with a cellular telephone, non-cellular telephone, pager, or computer.

Another object of this invention is to provide a communications device, as aforesaid, that is inexpensive to manufacture and reliable to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front view of a communications device according to a preferred embodiment of the present invention;

FIG. 2 is a front view of the communications device not having a keypad input device;

FIG. 3 is a front view of a remote device in use with the communications device as in FIG. 1;

FIG. 4 is a block diagram showing the electronic components of the communications device according to the present invention; and

FIG. 5 is a flowchart illustrating the logic performed by the processor during a setup procedure of the communications device.

### DESCRIPTION OF THE PREFERRED EMBODIMENT

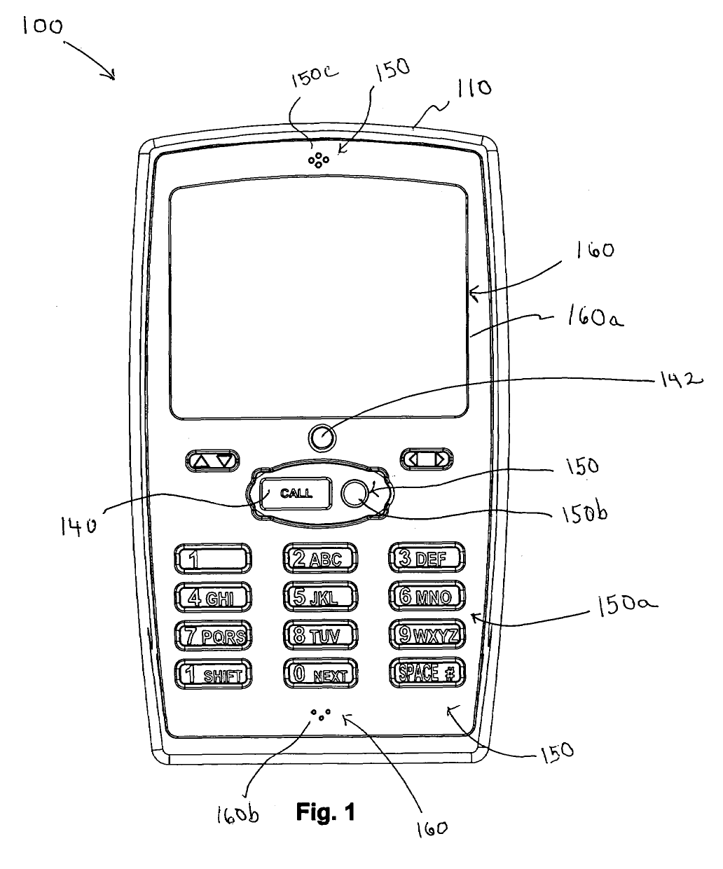

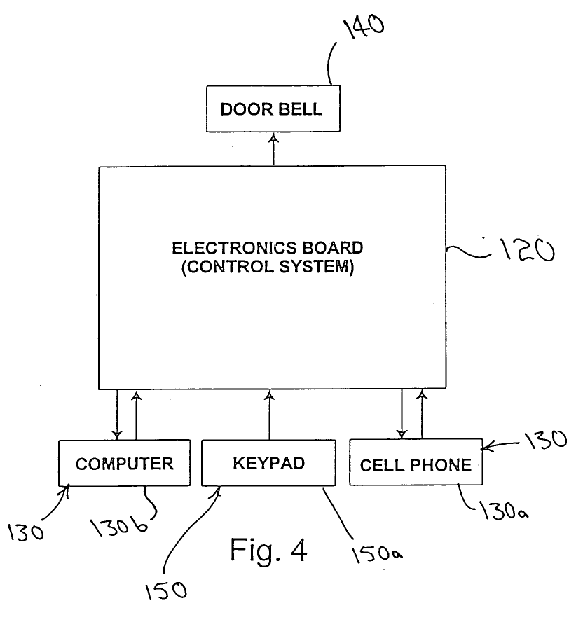

A communications device 100 according to the present invention will now be described in detail with reference to FIGS. 1 through 5 of the accompanying drawings. More particularly, a communications device 100 according to the current invention includes a housing 110 for mounting adjacent an entrance, such as a door or gate. The housing 110 is preferably weatherproof and may be constructed of plastic, composite, or another suitable material. Although the housing 110 is illustrated in the figures with a generally rectangular configuration, it is understood that other configurations would also be suitable.

A processor 120 is positioned in the housing 110, and the processor 120 is in data communication with means for transmitting data to at least one remote device 130 and means for receiving data from the at least one remote device 130. A remote device 130 may be a cellular telephone 130a, a non-cellular telephone, a computer 130b, or a pager, for example. The means for transmitting data and the means for receiving data may be, for example, a modem used to communicate with telephones (wireless and/or land-line telephones), pagers, and/or computers. Alternately, transmitter components common to cellular and pager devices may also be suitable.

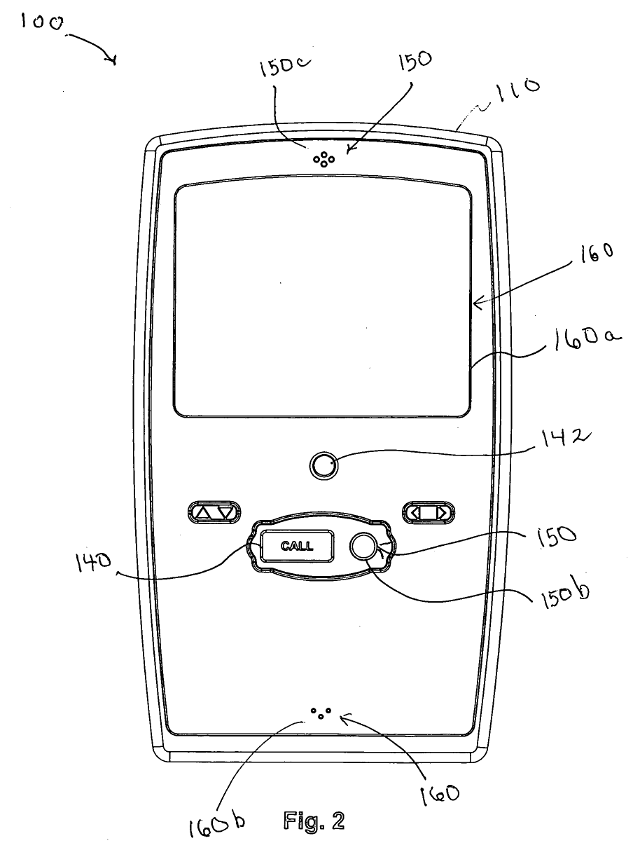

A first input device 140 (also referred to herein as an “actuator”) may be situated on the housing 110 for actuating the processor 120, and a second input device 150 may be in data communication with the processor 120 for inputting data to the processor 120 for transmission to the at least one remote device 130. The first input device 140 may be, for example, a button similar to a doorbell, a switch, a motion sensor, or a presence sensor. The second input device 150 may be, for example, a keypad 150a, a camera 150b, or a microphone 150c. Further, it is possible for multiple second input devices 150 to be included. In other words, a keypad 150a, a camera 150b, and/or a microphone 150c may be in data communication with the processor 120 for inputting data to the processor 120 for transmission to the at least one remote device 130. FIG. 2 illustrates the communications device 100 in a form not including a keypad. It is understood that the keypad may be a full QWERTY keyboard.

A data-conveying device 160 (for example, a display 160a or a speaker 160b) may also be situated in the housing in data communication with the processor 120 for presenting the data received from the at least one remote device 130. Further, it is possible for multiple data-conveying devices 160 to be in data communication with the processor 120 as described. In other words, a display 160a and a speaker 160b may both be in data communication with the processor 120 for presenting the data received from the at least one remote device 130.

The processor 120 may include various programming, such as programming for determining whether the processor 120 was actuated (by the actuator 140) in a first predetermined timeframe (e.g. 8 a.m. to 5 p.m.) or in a second predetermined timeframe (e.g. all other times of the day or night); causing the means for transmitting data to transmit the data to a first remote device 130 (e.g., a first cellular telephone) if the processor 120 was actuated in the first predetermined timeframe; and causing the means for transmitting data to transmit the data to a second remote device 130 (e.g., a second cellular telephone) if the processor 120 was actuated in the second predetermined timeframe. The processor 120 may include programming for setting the first and second predetermined timeframes based on data from one or more of the remote devices 130 or data from one or more of the second input devices 150. The processor may further or alternately include programming for selecting a first remote device 130 from a plurality of remote devices 130 and for selecting a second remote device 130 from a plurality of remote devices 130. If one of the remote devices 130 is a computer 130b having access to the internet, the processor 120 may include programming for setting a password for a website accessible through the internet to allow only authorized users to access the website, and the website may present the data from the second input device 150.

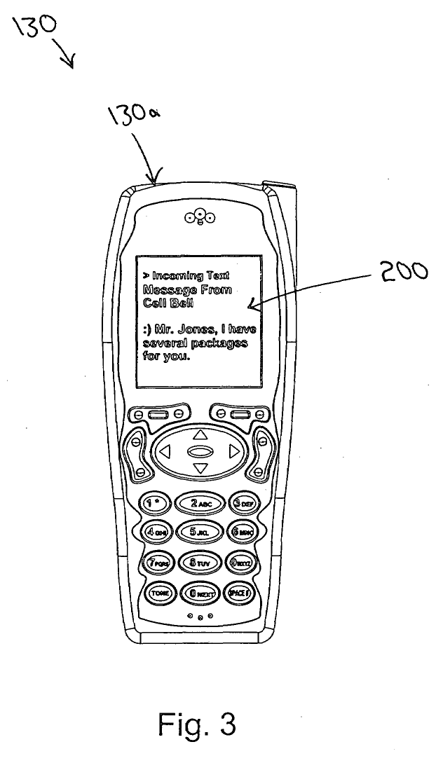

In use, the communications device 100 may be affixed adjacent an entry point, such as a door or a gate. A user (such as a delivery person, etc.) at the entry point may actuate the processor 120 with the actuator 140, and data (such as a request for delivery instructions or the delivery person's picture or a package's picture) may be input to the processor 120 through the keypad 150a, the camera 150b, and/or the microphone 150c. The processor 120 may then cause the means for transmitting data (discussed above) to transmit the data to the at least one remote device 130 (e.g., the cellular telephone 130a or the computer 130b), and the at least one remote device 130 may receive the data (as shown at reference numeral 200 in FIG. 3). The at least one remote device 130 may then transmit data to the means for receiving data (discussed above), and the processor 120 may cause the display 160a and/or the speaker 160b to output the data (such as delivery instructions, for example) received by the means for receiving data.

As discussed above, the processor may determine whether the processor 120 was actuated in a first predetermined timeframe (e.g., 8 a.m. to 5 p.m.) or in a second predetermined timeframe (e.g., all times besides 8 a.m. to 5 p.m.) and cause the means for transmitting data (discussed above) to transmit the data (such as the request for delivery instruction or the delivery person's picture or the package's picture) to the first remote device 130 (e.g., the first cellular telephone 130a) if the processor 120 was actuated in the first timeframe or to the second remote device 130 (e.g., the computer 130b or the second cellular telephone) if the processor 120 was actuated in the second timeframe. As also discussed above, the keypad 150a and/or one of the remote devices 130 (e.g., the first cellular telephone 130a or the computer 130b) may be used to set the first and second predetermined timeframes and to select the first and second remote devices 130 that correspond to the first and second predetermined timeframes from a plurality of remote devices 130.

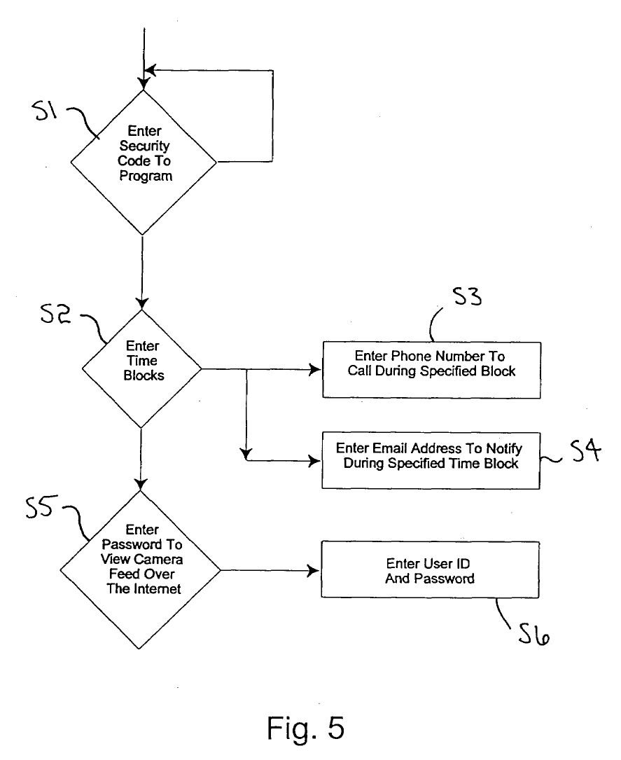

FIG. 5 is a flowchart illustrating a process that may be followed to set some of the options discussed above. At step S1, a user may enter a security code to the processor 120, such as through the keypad 150a, the cellular telephone 130a, or the computer 130b. If the security code is correctly entered, the process may continue to step S2. At step S2, the user may select the first and second predetermined timeframes as discussed above, such as through the keypad 150a, the cellular telephone 130a, or the computer 130b, for example. The user may then direct the process to step S3, step S4, or step S5. At step S3, the user may select a first remote device 150 to correspond to the first or second predetermined timeframe, such as by entering a telephone number. At step S4, the user may select a second remote device 150 to correspond to the first or second predetermined timeframe, such as be entering an email address. At step S5, the user may indicate whether he wishes to select a security code to view data at a computer 130b over the internet or a local network. If so, the process is directed to step S6, where the user may enter the security code to the processor 120.

The communications device 100 may be electrically connected to the main electrical power supply of a residence or business. In fact, it may be connected at the same point or as a replacement to a traditional doorbell button. A doorbell button 142 may be situated on the housing 110 and electrically connected through the residence power supply to a doorbell having a speaker positioned inside the residence or business. Accordingly, a visitor, whether it be a delivery person or otherwise, may press the doorbell button 142 to alert the resident or business employees of their presence at the door. If no one answers the call, the person at the door may press the actuator 140 to actuate the processor 120 to make contact with a remote device.

It is understood that while certain forms of this invention have been illustrated and described, it is not limited thereto except insofar as such limitations are included in the following claims and allowable functional equivalents thereof.

What is claimed is as follows:

1. A communications device, comprising:
a housing for mounting adjacent an entrance;
a processor in said housing, said processor being in data communication with means for transmitting data to at least one remote device and means for receiving data from said at least one remote device;
a first input device on said housing for actuating said processor;
a second input device in data communication with said processor for inputting data to said processor for transmission to said at least one remote device; and
a data-conveying device in data communication with said processor and being selected from the group consisting of a display and a speaker.

2. The communications device of claim 1, wherein:
said data-conveying device is a display; and
another data-conveying device is in data communication with said processor, said another data-conveying device being a speaker.

3. The communications device of claim 1, wherein said second input device is selected from the group consisting of a keypad, a camera, and a microphone.

4. The communications device of claim 3, further comprising a microphone in data communication with said processor for inputting data to said processor for transmission to said at least one remote device.

5. The communications device of claim 1, wherein said processor includes programming for:
determining whether said processor was actuated in a first predetermined timeframe or in a second predetermined timeframe;
causing said means for transmitting data to transmit said data to a first remote device if said processor was actuated in said first predetermined timeframe; and
causing said means for transmitting data to transmit said data to a second remote device if said processor was actuated in said second predetermined timeframe.

6. The communications device of claim 5, wherein said processor includes programming for setting said first and second predetermined timeframes based on data from said at least one remote device.

7. The communications device of claim 5, wherein said processor includes programming for setting said first and second predetermined timeframes based on data from said second input device.

8. The communications device of claim 5, wherein said processor includes programming for selecting said first remote device from a plurality of remote devices and for selecting said second remote device from said plurality of remote devices.

9. The communications device of claim 1, wherein one said remote device is selected from the group consisting of a cellular telephone, a non-cellular telephone, a computer, and a pager.

10. The communications device of claim 1, wherein:
one said remote device is a computer having access to the internet; and
said processor includes programming for setting a password for a website accessible through the internet to allow only authorized users to access said website, said website presenting said data from said second input device.

11. A communications device, comprising:
a housing for mounting adjacent an entrance;
a processor in said housing, said processor being in data communication with means for transmitting data to at least one remote device and means for receiving data from said at least one remote device;
an actuator on said housing for actuating said processor;
a keypad in data communication with said processor for inputting data to said processor for transmission to said at least one remote device;
a camera in data communication with said processor for inputting data to said processor for transmission to said at least one remote device;
a microphone in data communication with said processor for inputting data to said processor for transmission to said at least one remote device;
a display in data communication with said processor; and
a speaker in data communication with said processor.

12. The communications device of claim 11, wherein one said remote device is selected from the group consisting of a cellular telephone, a non-cellular telephone, a computer, and a pager.

13. The communications device of claim 11, wherein said processor includes programming for:
determining whether said processor was actuated in a first predetermined timeframe or in a second predetermined timeframe;
causing said means for transmitting data to transmit said data to a first remote device if said processor was actuated in said first predetermined timeframe; and
causing said means for transmitting data to transmit said data to a second remote device if said processor was actuated in said second predetermined timeframe.

14. The communications device of claim 13, wherein said processor includes programming for setting said first and second predetermined timeframes based on data from said at least one remote device.

15. The communications device of claim 13, wherein said processor includes programming for setting said first and second predetermined timeframes based on data from said keypad.

16. The communications device of claim 13, wherein said processor includes programming for selecting said first remote device from a plurality of remote devices and for selecting said second remote device from said plurality of remote devices.

17. The communications device as in claim 13 further comprising a doorbell button positioned on said housing for electrical connection to a doorbell situated in a residence.

18. A method of communicating between an entry point and a remote location, said method comprising the steps of:
affixing a communications device adjacent the entry point, said communications device including:
a weatherproof housing;
a processor in said housing, said processor being in data communication with means for transmitting data to at least one remote device and means for receiving data from said at least one remote device;
an actuator on said housing for actuating said processor;
a keypad in data communication with said processor for inputting data to said processor for transmission to said at least one remote device;
a camera in data communication with said processor for inputting data to said processor for transmission to said at least one remote device;
a microphone in data communication with said processor for inputting data to said processor for transmission to said at least one remote device;
a display in data communication with said processor; and
a speaker in data communication with said processor;
actuating the processor with said actuator;
inputting data to said processor through at least one of said keypad, said camera, and said microphone;
said processor causing said means for transmitting data to transmit said data to said at least one remote device;
said at least one remote device receiving said data;
said at least one remote device transmitting data to said means for receiving data; and
said processor causing at least one of said display and said speaker to output data received by said means for receiving data.

19. The method of claim 18, said method further comprising the steps of:
said processor determining whether said processor was actuated in a first predetermined timeframe or in a second predetermined timeframe;
said processor causing said means for transmitting data to transmit said data to a first remote device if said processor was actuated in said first predetermined timeframe; and
said processor causing said means for transmitting data to transmit said data to a second remote device if said processor was actuated in said second predetermined timeframe.

20. The method of claim 18, said method further comprising the steps of:
using said keypad to set said first and second predetermined timeframes; and
using said keypad to select said first and second remote devices from a plurality of remote devices.
